(19) United States
(12) Patent Application Publication
(10) Pub. No.: US 2011/0011165 A1
(43) Pub. Date: Jan. 20, 2011

(54) METHOD FOR PLANNING ROAD ASPHALTS

(75) Inventor: Gyorgy Gajari, Pilisvorosvar (HU)

Correspondence Address: DUANE MORRIS LLP - Princeton, PO BOX 5203, PRINCETON, NJ, 08543-5203, US

(73) Assignee: H-TPA INNOVACIOS ES MINOSEGVIZSGALO KFT, Budapest (HU)

(21) Appl. No.: 12/528,570

(22) PCT Filed: Feb. 25, 2008
(86) PCT No.: PCT/HU2008/000022

§ 371 Date: Sep. 30, 2010

(30) Foreign Application Priority Data
Feb. 26, 2007 (HU) P 07 00176
Jan. 28, 2008 (HU) P 08 00053

(51) Int. Cl. G01N 11/00; G01F 17/00

(52) U.S. Cl. 73/61.78; 73/149

(57) ABSTRACT

The subject of the present invention is a new method for designing road asphalts, comprising:—the determination of the optimal bitumen content with compacting experiments using samples made of asphalt mixtures; the optimal bitumen content being the one at which the receptive void volume has a minimum value, depending on the bitumen content; that is, where the compactness of the sample is the highest, and by changing the mass rates in the asphalt mixture, the bitumen content is set to the optimal bitumen content at most. The optimal bitumen content provides the possibility to aim for reaching the highest compactness, i.e. the smallest possible void volume which provides the most favorable fatigue and solidity characteristics.

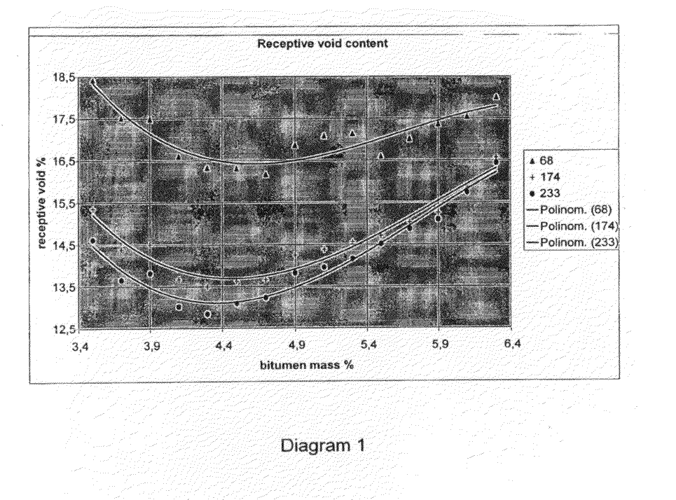

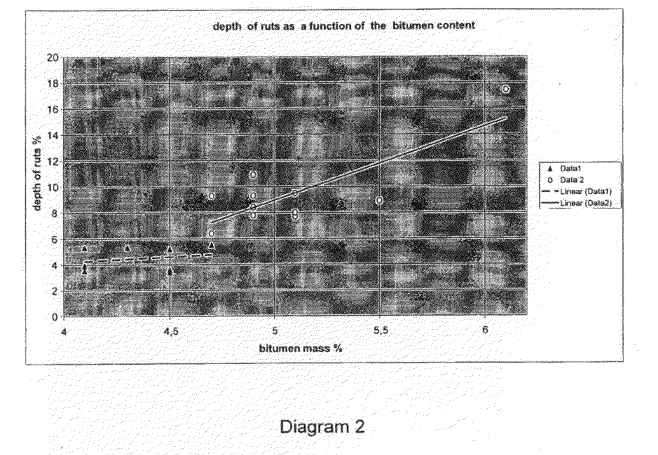

The present invention relates to a new method for planning asphalts.

Particularly, the invention relates to the designing of asphalts to be built into the structure of roadways. The subject of the invention is a theoretically grounded method for defining the quantitative rates of the components of common asphalt in order to minimize the chance of rutting.

The asphalt components of roadway structures are subjected to significant mechanical stress due to heavy traffic and extreme weather conditions, such as great temperature variation. Traffic and heavy vehicles strain the road, and after a while this leads to deterioration. Due to temperature variation the asphalt may soften and wheel tracks may cause permanent deformations in it. In cold weather, the asphalt becomes rigid, resulting in frost riving, which leads to the forming of potholes.

These problems may seriously damage vehicles, impairing the tires, the wheel-discs, the hanging and the suspension. Besides the property damage, this may lead to road accidents.

Thus, the asphalt components of roadway structures are subjected to significant physical stress due to traffic and weather. For the reasons mentioned above, the appropriate quality of road asphalts is highly important for the participants of the traffic.

Stress resistant asphalt has three important features, as follows:

resistance to permanent deformation at high temperature (>=60° C.);

fatigue resistance to repeating bending stress caused by traffic;

resistance to frost-crack at low temperature.

The first two features are important because of the stress caused by traffic, the latter is necessary regardless of traffic.

Before the asphalt is built into the roadway structure, the suitability of the designed asphalt mixture is tested by examining the important properties mentioned above. The tests are the following:

Rutting

Due to the increased truck traffic of the recent decades, longitudinal dents (permanent deformations) have formed on the tracks of wheels on the roadways, primarily in the high-temperature seasons. The laboratory test, conducted with English, French or German methods, simulates the stress caused by wheels. In all three cases, a wheel moves back and forth on an asphalt plate test piece. The temperature of the test piece and its environment is constant: 60° C. In a few hours, the loaded wheel passes over a given point of the test piece thousands of times. The depth of the forming “rut” characterizes the examined asphalt's resistance to permanent (plastic) deformation at high temperature.

Bending Endurance Test

Nowadays, the so-called cracking or “alligatoring”, which is the result of fatigue caused by repeating bending stress, is rarely to be seen on the paving of main roads. Due to the wheel-load, the surface of the road subsides. The depression moves together with the wheels. The moving depression results in the fatiguing bending stress of the road structure. The cracks caused by fatigue can only form in rigid asphalt, that is, at low temperature when the asphalt behaves as a solid body.

The laboratory test consists of the bending of a prism-shaped asphalt sample into alternating directions. There are clamped beams at both ends of the prism. The alternate bending is caused by the periodic, alternating directed load, which is perpendicular to the longitudinal axis. The frequency of the period of the load is 10 Hz; the standard temperature of the sample is 10-15° C. The asphalt is considered ruined if the initial flexural rigidity of the prism is decreased to its half. To reach this value, the testing machine usually bends the sample hundreds of thousands of times.

Testing of Cold Behavior

The laboratory tests determine the so-called cracking temperature of the asphalt. Thermic tensile stresses accumulate in the cooling asphalt, if the speed of cooling is high enough and contraction is precluded. The test-piece breaks if the accumulated tensile stresses reach the tensile strength. The cracking temperature is the temperature at which the breaking occurs.

Thermic cracks often appear on newly built highways as well; mostly due to the use of “hard” bitumens. The softening temperature of these bitumens is higher, therefore, their modulus is larger. One of the purposes of using these bitumens is to prevent rutting. However, the behavior of these bitumens in cold is disadvantageous; therefore, North-European countries do not use them.

Numerous attempts have been made to produce roadways which are highly resistant to the failures mentioned above. The HU 192 606 Hungarian patent describes an asphalt pavement, particularly a wearing course, and the method for its production. It is mentioned in the teaching part of the technical solution that the practical method to determine the binding material need of the asphalt mixture is a laboratory suitability test. This test is based on the values defined for Marshall test bodies. (The Marshall-method is described in detail later.) The description mainly details the mixing rates of the components.

The primary aim of the asphalt designing method described in the patent is to improve the asphalt's resistance to permanent deformations occurring at high temperature. Unlike the known method mentioned above, the present invention does not attempt to reach this goal by using hard bitumens or other additives, but exclusively by determining the appropriate bitumen content and by using asphalts with high compactness (small void volume). Unlike the methods used hitherto, the theoretical basis of the method described in the present invention can be verified not only by our own experiments, but also by a mechanical theory, which was never used in the field of road asphalt producing before. This theory dealing with granular materials is known in the literature of soil mechanics:
Andrew Schofield and Peter Wroth:
Critical State Soil Mechanics, McGraw-HILL, LONDON, 1968; and
G. Gudehus:
A comprehensive constitutive equitation for granular materials, Soils and Foundations, 36(1):1-12, 1996.

We have to emphasize that it has not been recognized before that the connections described in the field of soil mechanics can be used in the producing of asphalt mixtures.

In creating the invention the correlation between permanent deformation and the solidity of high temperature asphalts was taken into consideration.

One of the determining factors of the asphalt's solidity is the binding material, that is, bitumen. The consistency of bitumen is strongly affected by temperature. Over 40-60° C., bitumen is liquid, over −10° C. it is plastic-solid, and below −10° C. it behaves as a rigid solid body. As the “cohesion” of asphalt is provided by bitumen, cohesion highly depends on temperature.

In the field of technical mechanics, in the case of granular materials, such as soils, the notion of solidity includes another quantity besides cohesion: viscosity.
The viscosity of asphalt is provided by the mineral additive, that is, the crushed stones frame. Viscosity may be considered independent of temperature. The degree of viscosity described with the so-called viscosity angle.
The two parameters of “criterion of failure” or “criterion of plasticity” are:
cohesion: c, and
viscosity angle: φ.

Under laboratory circumstances, with a certain technique, cohesion can be measured. According to our measurements, cohesion exponentially decreases by increasing temperature; it does not reach 100 kPa at 60° C. This value is highly dependant on the speed of loading, therefore, in case of static loading, cohesion is even smaller than the value above. Hence, at high temperatures, rutting is impeded only by the viscosity of asphalt.

The present practice of asphalt designing includes several mistakes.

According to present methods, asphalt planning consists of determining the rates of the components, that is:
mineral additive (stone frame)
bitumen
free void volume (pore volume containing only air).
   In the case of each mixture, determination is not possible by theoretical calculation, only by experiments.

It is an empirical fact that there is a close connection between compactness and solidity: the higher the degree of compactness, the greater the solidity of asphalt is.

At high temperature, adequate free void content is important for the resistance to permanent deformation (friction resistance). However, the free void content decreases the asphalt's fatigue resistance.

It is also known that the effect of bitumen content is opposite to that of the void content: it increases the asphalt's fatigue resistance and decreases the asphalt's resistance to permanent deformation.

The third important characteristic, resistance to thermic cracking, is mainly determined by the quality (hardness) of bitumen.

The present day procedures are based on the empirical knowledge described above. One of the main problems of the present practice is the opposite effect of the void content and the bitumen content. Due to the lack of theoretical background, there is no good solution to this problem in the present practice. The proneness to permanent deformation caused by the relatively high bitumen content is balanced only by the use of bitumens with a high modulus (hard bitumens). However, as it was already mentioned above, this practice has an unfavorable effect on the asphalt's behavior in cold.

Solutions to the problem are described in the following references:

The HU 201 369 patent describes a method for producing asphalt concrete which can be spread in thin layers. In the teaching, the inventors emphasize the importance of void volume, which they try to calculate from the mass ratio of the asphalt's components.

The void content of asphalt mixtures with qualitatively and quantitatively exactly defined components is considered to be of a high importance according to the following publications as well: JP 90 12897 publication, HU 218 509 patent, and Zhai H.; Bahaia, H., U., Erickson, S.: “Effect of film thickness on rheological behavior of asphalt binders”, Transportation Research Record, 1728, 7-14, 2000 (C.A. 135: 141228). A similar method is described in: Ozawa Koichi: “Design method for mixing formulas of asphalt mixtures considering aggregate voids”, Journal of Japan Petroleum Institute, 45(2), 70-76, 2002 (C. A. 136: 373586).

However, in the asphalt designing method, the significance of aggregate voids—as it was already mentioned above—was not taken into consideration with due measure for improving the pavement's qualities.

Hungarian asphalt designing is practically a variant of the Marshall method used in Europe (Nemesdy E: Útpályaszerkezetek, Útépítéstan II., Tankönyvkiadó, Budapest 1989; and Út 2-3. 301:2006 Útépítési aszfaltkeverékek és út-pályaszerkezeti aszfaltrétegek, Magyar Útügyi Társaság).

In the U.S.A., the SHRP Superpave method is used. (National Research Council: Strategic Highway Research Program, Washington, D.C. 1994).

In France, a new method was developed, which differs in some details from the two methods mentioned above. Henceforward, only the Marshall and the SHRP Superpave methods are going to be referred to.

The Marshall method calculates the volumetric rates of the components of the asphalt from

the grain size distribution of the mineral aggregate,

work used for compaction,

and the bitumen content.

The use of observations derived from the method allows for the limiting grading curve of the mineral to be specified by a standard, so the experimental work can be largely decreased.

A great advantage of the method is that the so-called Marshall Drop Hammer, used for the compaction of asphalt mixtures, is an internationally unified device; therefore, the samples are the same everywhere. The apparatus compacts dynamically the asphalt with a weight of a defined mass falling from a given height. The compaction work is determined by the specified number of drops. In the Hungarian version of the method, the cylindrical sample with a diameter of 100 mm and a height of 60 mm is compacted with 2×75 drops. According to the observations, the compaction work is in accordance with the compaction caused by traffic.

Due to the specified grain-size distribution and compaction, asphalt designing is reduced mainly to the determination of the bitumen content. 3-5 samples with different bitumen contents are used for this measurement, based on the free void content, or the so-called Marshall Stability, or the Marshall Flow of the sample.

That bitumen content is selected at which the value of one of the above quantities is equal to the empirical values specified by standards.
(The empirical value of the free void content guarantees primarily the resistance to permanent deformation. The Marshall Stability and Flow characterize the sample's resistance to deformation and its behavior at a given temperature, which represents the appropriate solidity.)

However, for the appropriate fatigue resistance, it has to be checked whether the bitumen content determined in the above procedure reaches the value recommended in the standard.

As opposed to the Marshall method, in the case of the SHRP Superpave method, the limiting grading curves of the solid mineral aggregate are not prescribed.

The compaction work and the apparatus used for it, the gyratory compactor, are also different from those of the Marshall method. The main differences are:
the amount of compaction work depends on the anticipated traffic level,
the gyratory compactor does not use dynamic impact energy for compacting, rather, it compacts by periodic shearing, which is similar to rolling stress. The number of cycles determines the compacting work.
   The criterion for selecting the bitumen content is that the free void content has to be 4% by volume, at any design number of gyrations, regardless of the asphalt's type, that is, whether it is wearing, binding or base course.

An important part of the method is to examine with laboratory rutting and fatiguing tests the level of the desired important characteristics of the designed asphalt.

Recently, the Marshall method has been completed with these so-called performance tests in Hungary as well.

It is important and interesting to state that
the asphalts designed with traditional methods often do not pass the rutting test,
in spite of the rutting tests, on the finished roads rutting occurs frequently.

All in all, it can be stated that currently asphalt designing is based on empirical values. There is no strictly verified theoretical basis for the designing of asphalt blends. The present practice does not have a theoretical basis which points out the connection between the bitumen content and the void content (compactness) on the one side, and between the modulus and solidity of the asphalt on the other side. In the present practice, resistance to permanent deformity and the decrease of proneness to rutting is tried to be achieved by the use of bitumens with a high modulus (hard bitumens).

The new method for designing asphalt blends described in the present invention is based on the essential recognition that there is an analogy between the behavior of high temperature asphalt and soils. First, asphalt, just like soils, consists of a granular matrix of a mineral origin; second, the high temperature bitumen filling the pores, as it is a viscous liquid, is similar to the water filling the pores of soils.

To make the invention more understandable, the notions of “perceptive void” and “compactness” have to be defined. The perceptive void is the total pore volume, or void volume, among the grains of the mineral aggregate. One part of this void is filled by bitumen; the other is filled by air [MSZ EN 12697-8]. If the notion of compactness is used exclusively in connection with the mineral aggregate, then compactness can be measured with the volume of the perceptive void. The smaller the void volume, i.e. the perceptive void, among the solid grains is, the higher the compactness is. The void volume may be reduced by compacting, but it cannot be totally eliminated without the deformation and destruction of the mineral grains, since the grain do not fill the space perfectly. Assuming a given compacting work, a smallest void volume, or a highest compactness exists.

Several schools have developed for the mathematical description of the mechanical behavior of soils (as it was already mentioned above). All of these acknowledge the following experimental facts:
Deformity resistance is measured with “modulus” or “rigidity”. This is the quotient of the stress (loading tension) and the inherent deformation (elongation). The modulus increases if the compactness of the granular material increases and/or if the omnidirectional (isotropic) pressure holding the granular material together increases.
Shearing strength also increases if the compactness and the pressure increase. Shearing strength means the highest shearing resistance (tension), in case of an omnidirectional (isotropic) pressure.
In case of a monotonic increasing shearing stress, the compactness of the grain aggregation can change, even if the omnidirectional (isotropic) pressure is constant.
In case of a periodically changing (cyclic) shear, the grain aggregate compresses, even if the omnidirectional (isotropic) pressure is constant. Due to the cyclic shearing stress, the compactness of the grain aggregate reaches the highest compactness, that is, the smallest receptive void inherent to the given isotropic pressure.

It is another significant observation that the compactability of granular materials increases if the grain aggregate contains some liquid. That is, in dry condition, when the friction among the grains is high, larger voids remain among the grains compared to the case when the liquid reduces the friction as a lubricant. On the other hand, if the liquid's volume is larger than the pore volume, then the incompressible liquid hinders the compacting. In soil mechanics, compactability is tested by the so-called Proctor-test; in asphalt mechanics, compactability is tested with gyratory compactor, or incidentally with Marshall Drop Hammer. [MSZ EN 12697-31, MSZ EN 12697-30].

In creating the present invention, our starting point was the assumption that the optimal bitumen content of an asphalt is the bitumen content at which, in the case of a given compacting work, the highest compactness or the smallest receptive void occurs. We proved by our experiments the existence of the optimal bitumen content in the above sense.

The theoretical background of the asphalt designing method described in the present invention consists of the conclusions from the experimental facts mentioned above. These are the following:
1/ At high temperature, the highest modulus and solidity of the asphalt is ensured by the optimal bitumen content, because of the highest reachable compactness by an arbitrary compacting work. Therefore, the optimal bitumen content is an essential criterion for the method of the present invention. This characteristic practically refers to the mass rates of the asphalt mixture.
2/ After determining the optimal bitumen content, it is practical to determine the volume rates as well. The size of the receptive void is of a high importance, since this is the only factor determining modulus and solidity. The highest possible compactness provides the greatest resistance to permanent deformation. Therefore, the obligatory minimal free void volume of the present practice should not be complied with, because of its compactness reducing effect. According to the present invention, the highest possible compactness is to be reached.

3/ If the binder coating on the grains is not even (the grains are not covered everywhere with bitumen), the bitumen content has to be increased. According to the present invention, the increasing of the bitumen content is reached only by choosing the appropriate grain-size distribution. The grain-size distribution is one of the determining factors of the optimal bitumen content. The increasing of the value of the bitumen content is reached by choosing the appropriate grain-size distribution, so that the bitumen content is not higher than the optimal value.

The present invention contemplates a procedure for designing road asphalts, comprising:—the determination of the optimal bitumen content with compacting experiments using samples made of asphalt mixtures; the optimal bitumen content being the one at which the receptive void volume has a minimum value, depending on the bitumen content; that is, where the compactness of the sample is the highest, and by changing the mass rates in the asphalt mixture, the bitumen content is set no higher than the optimal bitumen content.

After the above procedure, favorably the volume rates of the asphalt mixture with the optimal bitumen content is determined as well; by making samples with different compactness from the mixtures with optimal bitumen content, by different amounts of compacting work; then determining the fatigue resistance of the samples by known methods; choosing the sample which corresponds to the fatigue criterion derived from the traffic demand; and executing the compacting work required for producing the sample.

The steps of the determination of the optimal bitumen content are to be repeated if required, with the same compacting work, the same kind of bitumen, and optionally with the additives, and exclusively with mineral matrixes with different grain-size distributions, until a grain-size distribution is developed which is suitable for an even bitumen coating.

The use of the criterion of optimal bitumen content and aiming at the highest compactness makes possible the use of bitumens with a low softening point, that is, “soft” bitumens. Therefore, with the method of the present invention, asphalts with favorable “cold behavior” can be produced.

According to the method of the present invention, the obligatory minimal free void does not hinder the compaction of the asphalt, and the highest possible compactness has a favorable effect on the fatigue resistance as well.

The theoretical basis of the method of the present invention is supported and demonstrated by our experimental results described in Examples 1, 2, and Diagrams 1, 2 below. The following examples are non-limiting; they are only meant to illustrate the invention.

### EXAMPLE 1

### Determination of the Optimal Bitumen Content as a Function of the Receptive Void

We conducted compacting experiments by gyratory compactor on AB-12/F type asphalt concrete blend (the grain-size distribution of the mineral aggregate responds to this standardized type), using B 50/70 road bitumen. The compacting work is represented by the parameter of cubic polynomials fitted with the least squares method and by the compacting revolution number of the gyrator (68—data marked with triangles on the diagram, 174—data marked with + signs on the diagram, and 233—data marked with circles on the diagram.) Increasing parameters represent increasing revolution numbers, that is, more compacting work. Based on the diagram, it can be established that by more compacting work compactness can be increased. However, the optimal bitumen content inherent to the minimum of the receptive void decreases only slightly when the compactness increases. At the highest revolution number, the smallest receptive void volume can be reached at 4.3 mass percent of bitumen content. Because of the imperfectness of the measurement of the receptive void volume, the suitable value of the optimal bitumen content will be 0.2-0.3 mass percent smaller than the measured value. In this case, the desired optimal value is 4-4.1 mass percent of bitumen content. The value “recommended” by the traditional methods is higher than 5.1 mass percent for the given type of asphalt mixture. That is, the new method results in a 1% lower bitumen content.

### EXAMPLE 2

### Determination of the Depth of Ruts as a Function of the Bitumen Content

Diagram 2 summarizes the results of the rutting experiments (conducted by so-called “small-wheeled device”) for the same AB-12/F type asphalt as in Example 1, using samples of different bitumen contents.

For this type of asphalt, 6% is the admissible value for the depth of ruts (referring to the thickness of the asphalt layer.) It can be observed that if the bitumen content is smaller than the optimal, the depth of ruts does not exceed the admissible value (dashed line on Diagram 2., data marked with triangles); but if the bitumen content is a few tenth percents higher than the optimal, then the depth of ruts exceeds the admissible value (continuous line on Diagram 2, data marked with circles).

As it can be seen, the most significant part of the new asphalt designing method of the present invention is the determination procedure of the optimal bitumen content. The procedure consists of the following phases:

According to the known and used laboratory method, mixtures with different bitumen contents are made of bitumen and the selected mineral aggregate, on the temperature adequate for the given bitumen type. The bitumen content of the mixtures is increased systematically; suitably by 0.2-0.5 mass percent. At least 5 mixtures with different bitumen contents are made this way. (The values given above are not obligatory; they are only recommended values.) The mixtures are compacted by compacting devices established in asphalt laboratories. Compacting by gyrator [MSZN EN 12697-31] is to be preferred to compacting by Marshall Drop Hammer [MSZN EN 12697-30]. Equal amounts of compacting work are used for the different mixtures (equal revolution numbers or drop numbers, respectively).

The density of the compacted asphalt samples is measured, and then, with knowledge of the density of the bitumen and the mineral aggregate, the receptive void volumes [MSZN EN 12697-8] are calculated using the known calculative algorithms. Then the optimal bitumen content inherent to the given compacting work is determined, according to the above-mentioned criterion. Because of the imperfectness of the measurement of the receptive void volume, the bitumen content which was determined at the smallest measured receptive void volume is decreased by 0.2-0.3 mass percent, and this lower value will be the optimal bitumen content.

If the practical upper limit of compatibility was not reached during the first compacting, then the compacting and the determination of the optimal bitumen content has to be repeated necessarily using more compacting work, in order to determine the optimal bitumen content inherent to the practical upper limit of compatibility. The interval of the variation of the optimal bitumen content is determined by using different compacting works.

After the above procedure, the smallest value of the optimal bitumen content adherent to the biggest amount of compacting work can be safely determined. This bitumen content enables the asphalt to offer the highest possible resistance to deformation, even in case of extremely high traffic load.

By determining the optimal bitumen content, the asphalt's mass rates are designed. However, besides the mass ratio, the built-in asphalt's solidity, fatigue and mechanical characteristics in general are significantly affected by the volume composition (compactness) as well. The volume composition is the function of the bitumen content and the compacting work, in case of a given mineral aggregate (grain-size distribution). Concerning the volume composition, using the method described in the present invention for determining the optimal bitumen content results in the highest possible compactness, i.e. the smallest receptive void volume, in case of arbitrary compacting work. Higher compactness affects advantageously the mechanical characteristics, that is, every significant property of the asphalt, according to the referred literature as well.

Designing the compacting work, consequently, designing the volume composition is a further phase of the procedure, at which the fatigue resistance [MSZ EN 12697-24] is taken into consideration, so the asphalt designing method continues with the following steps:

Out of mixtures with the same, optimal bitumen (mass) content, sample bodies with different volume compositions (compactness) are made, using different compacting works, to be used for experiments for determining the fatigue resistance [MSZ EN 12697-24].

The fatigue resistance of the sample bodies with different compactness is determined, according to the known, standardized laboratory technology [MSZ EN 12697-24].

The volume composition, and consequently, the compacting work, which meets the required fatigue criterion derived from the traffic demand [MSZ EN 12697-24].

If the designing procedure results in such a low bitumen content that it has to be increased, for instance, to get the bitumen cover the mineral grains better, or to increase the fatigue resistance, then the procedure is to be repeated with a mineral matrix of a different grain-size distribution until we get a higher optimal bitumen content.

The new asphalt designing method of the present invention not only improves the mechanical properties of the pavement, but it has economical advantages as well. The costs are reduced for the building contractor and the operator as well, since:
due to the new criterion, the building contractor needs asphalt with a lower bitumen content,
due to the elimination of rutting, the operating costs are reduced.

The tests were conducted according to the following standards concerning the testing of asphalt mixtures, particularly warm asphalt mixtures: MSZ EN 12697-8 (Determination of void characteristics of bituminous specimens), MSZ EN 12697-24 (Resistance to fatigue), MSZ EN 12697-30 (Specimen preparation by impact compactor), MSZ EN 12697-31 (Specimen preparation by gyratory compactor), MSZ EN 12697-34 (Marshall test).

1. Method for designing road asphalts, comprising the determination of the optimal bitumen content with compacting experiments using samples made of asphalt mixtures; the optimal bitumen content being the one at which the receptive void volume has a minimum value, depending on the bitumen content; that is, where the compactness of the sample is the highest, and by changing the mass rates in the asphalt mixture, the bitumen content is set to the optimal bitumen content at most.

2. The method of claim 1, comprising the volume rates of the asphalt mixture with the optimal bitumen content is determined as well; by making samples with different compactness from the mixtures with optimal bitumen content, by different amounts of compacting work; then determining the fatigue resistance of the samples by known methods; choosing the sample which corresponds to the fatigue criterion derived from the traffic demand; and prescribing for the building of the asphalt the compacting work required for producing the sample.

3. The Method of claim 1 and 2, comprising the steps of the determination of the optimal bitumen content are to be repeated, with the same compacting work, the same kind of bitumen, and optionally with the additives, and exclusively with mineral matrixes with different grain-size distributions, until, by increasing the value of the optimal content with grain-size distribution, a grain-size distribution is developed which is suitable for an even bitumen coating.
